(19) United States
(12) Patent Application Publication
(10) Pub. No.: US 2012/0227493 A1
(43) Pub. Date: Sep. 13, 2012

(54) SOLDERING METHOD, GYROSCOPE AND SOLDERED PART

(75) Inventor: Paul Vandebeuque, Paris (FR)

(73) Assignee: SAGEM DEFENSE SECURITE, Paris (FR)

(21) Appl. No.: 13/509,518

(22) PCT Filed: Nov. 10, 2010
(86) PCT No.: PCT/EP10/67221

§ 371 Date: May 11, 2012

Related U.S. Application Data
(60) Provisional application No. 61/324,505, filed on Apr. 15, 2010.

(30) Foreign Application Priority Data
Nov. 12, 2009 (FR) 09/05429

(51) Int. Cl. B23K 1/20; B23K 31/02; G01P 15/14

(52) U.S. Cl. 73/504.18; 228/203

(57) ABSTRACT

The invention relates to a method of soldering a conducting body to a substrate using an alloy chosen from either a tin-silver alloy or a tin-silver-copper alloy. The method comprises metallization of the substrate by depositing a tie layer on the substrate, depositing a diffusion barrier layer, or depositing a wetting layer comprising gold. The tie layer having any one of the chemical components chosen from chromium, titanium or titanium alloy. The diffusion barrier layer comprising a material chosen from platinum or palladium.

### PRIORITY CLAIM

The present application is a National Phase entry of PCT Application No. PCT/EP2010/067221, filed Nov. 10, 2010, which claims priority from French application Ser. No. 09/05429, filed Nov. 12, 2009, and U.S. Patent Application No. 61/324,505, filed Apr. 15, 2010, the disclosures of which are hereby incorporated by reference herein in their entirety.

### FIELD OF THE INVENTION

The present invention relates generally to gyroscopes and in particular, the invention relates to a method of soldering a conducting body to a substrate using a tin-silver alloy or a tin-silver-copper alloy, as well as to a gyroscope and to a soldered part that are manufactured by this soldering method.

### BACKGROUND OF THE INVENTION

The invention relates to a lead-free soldering method in compliance with the directive RoHS (2002/95/CE), to a gyroscope and to a soldered part that are manufactured using this soldering method.

Document EP 1 542 271 discloses a method of soldering a semiconductor light emitting element on a substrate which reduces the thermal damage to the semiconductor light emitting element. According to this method, a submount is deposited on the substrate. The submount comprises the successive following layers: an adhesion layer comprising platinium or titanium; a barrier layer comprising palladium or platinium; an electrode layer; an adhesion layer comprising titanium and platinium and finally, a solder layer.

The gold layer serves as a electrical conducting layer adapted to control the light emmiting element. This gold layer is not melted with the other layers after soldering. A platinium layer is deposited under and above the gold layer to ensure that this gold layer will not merged with the tin-silver alloy layer and the adhesion layer.

However, the submount comprises a large numbers of layers. So, it is complex and expensive to produce in a series process.

Further, this submount presents a thickness too high to be compatible with some technical applications.

In particular, the invention relates to a method of soldering a conducting body to a substrate using a tin-silver alloy or a tin-silver-copper alloy, as well as to a gyroscope and to a soldered part that are manufactured by this soldering method.

At the present time, there is no method for lead-free tin soldering to a thin film. This is because of the higher reflow temperature of a tin-silver solder, as compared to a tin-lead solder, increases dissolution and requires the thicknesses of these films to be increased. On brittle substrates, such as for example ceramic-type substrates, it is desirable to lower the mechanical stresses and therefore to limit the thicknesses of thin films.

### SUMMARY OF THE INVENTION

The object of the present invention is to provide a method of lead-free soldering to thin films.

For this purpose, one subject of the invention is a method of soldering an at least partially conducting body, called a conducting body, to a substrate using an alloy chosen from a tin-silver alloy and a tin-silver-copper alloy, the method comprises the following steps:

metallization of the substrate, said metallization step comprising a step of depositing a tie layer on the substrate and a step of depositing a diffusion barrier layer, said tie layer having any one of the chemical components chosen from chromium, titanium and a titanium alloy, said diffusion barrier layer comprising a material chosen from platinum and palladium; and

application of a solder between the conducting body and the metallized substrate, said solder comprising an alloy chosen from a tin-silver alloy and a tin-silver-copper alloy;

characterized in that the method comprises depositing a wetting layer comprising gold; said wetting layer being deposited between the step of depositing a diffusion barrier layer and the step of applying a solder.

This soldering method includes the deposition of a diffusion barrier comprising a material chosen from platinum and palladium and the deposition of a tie layer and optionally of a wetting layer so as to compensate for the drawbacks of the diffusion barrier layer.

According to particular embodiments, the method comprises one or more of the following features:

the tie layer is a thin film having a thickness of between 5 and 50 nanometers;

the tie layer has a thickness of about 30 nanometers;

the diffusion barrier layer is a thin film having a thickness of between about 100 nanometers and 1500 nanometers;

the diffusion barrier layer has a thickness of about 200 nanometers;

the solder is deposited straight on the wetting layer;

the wetting layer is a thin film having a thickness approximately equal to 0.4% of the thickness of the solder;

the wetting layer is a thin film having a thickness of between about 5 nanometers and 1 micron;

the wetting layer has a thickness of about 50 nanometers; and

the tie layer comprises chromium and the diffusion barrier layer comprises platinum.

Moreover, a gyroscope, for example of the type described in patent application FR 2 805 039, includes a silica electrode carrier joined to a base via conducting support rods. A cover, containing the resonator, the electrode carrier and the support rods, is hermetically fastened onto the base. A high vacuum is then created beneath the cover.

Electrodes are formed on a portion of the upper surface of the electrode carrier. They are each connected to a support rod in order to receive excitation signals and to transmit detection signals.

For this purpose, the electrode carrier comprises metal bushes mounted in through-holes. The support rods are fitted into the bushes and fastened to them with the aid of conducting adhesive, particularly an epoxy adhesive.

However, these adhesives outgas strongly. This outgassing makes it difficult to create and above all to maintain a high vacuum beneath the cover. It is desirable for the electrode carrier to be firmly fastened to the support rods while minimizing this outgassing and ensuring that there is electrical conduction between the electrode carrier and the support rods.

The subject of the invention is also a gyroscope comprising:

a resonator;

a substrate supporting the resonator; and

an at least partially conducting body, called a conducting body, fastened to the substrate.

The gyroscope being noteworthy in that the conducting body is fastened by a solder to the substrate by implementing the soldering method according to any one of the aforementioned embodiments.

As a variant, in the gyroscope according to the invention, the substrate includes at least one excitation/detection electrode, said electrode being connected to the body.

Finally, another subject of the invention is a soldered part comprising at least a substrate and an at least partially conducting body, called conducting body, fastened to the substrate, which part is noteworthy in that the conducting body is fastened by a solder to the substrate by implementing the soldering method according to any one of the aforementioned embodiments.

### BRIEF DESCRIPTION OF THE DRAWINGS

The invention will be better understood on reading the following description, given solely by way of example, and with reference to the drawings in which:

FIG. 1 is a block diagram of the soldering method according to the invention;

FIG. 2 is a schematic view in cross section of a soldered part; and

FIG. 3 is a schematic view in axial section of a gyroscope according to the invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE DRAWINGS

The invention relates to a method of soldering a body 2 to a substrate 4. The body 2 is at least partially conducting. It is called a conducting body hereafter. In particular, it has at least one conducting face intended to be soldered to the substrate 4. The conducting face is made of a conducting material such as, for example, a metallic material or a composite material comprising a metal.

The substrate 4 is for example formed by silica, silicon, a ceramic, metal oxides, crystalline materials or glass.

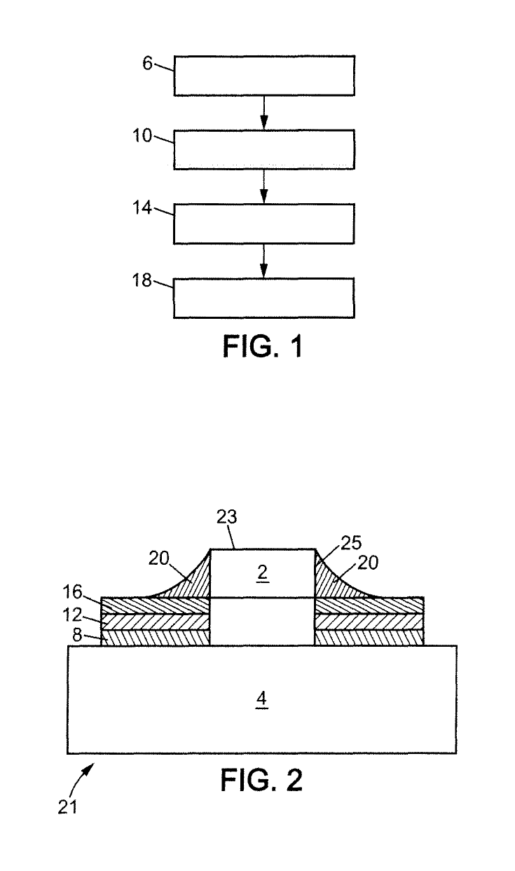

Referring to FIGS. 1 and 2, the soldering method starts with a step of metallizing the substrate. This metallization step comprises a step 6 of depositing a tie layer 8 on the substrate 4, a step 10 of depositing a diffusion barrier layer 12 on the tie layer 8 and a step 14 of depositing a wetting layer 16 on the diffusion barrier layer 12.

The tie layer 8 is suitable for ensuring that the body 2 is strongly tied to the substrate 4. The tie layer 8 is, for example, made of chromium. It has a thickness of between about 5 and 50 nanometers. Preferably, this layer has a thickness of about 30 nanometers.

As a variant, this tie layer 8 is made of titanium or one of its alloys.

The diffusion barrier layer 12 is for example made of platinum, palladium or nickel. The diffusion barrier layer 12 creates a diffusion barrier suitable for reducing the rate of advance of tin from the soldering alloy into the substrate 4. Moreover, this diffusion barrier layer 12 creates non-brittle intermetallics with tin.

The diffusion barrier layer 12 is a thin film having a thickness of between about 100 and 1500 nanometers. Preferably, this layer 12 has a thickness of about 200 nanometers.

The wetting layer 16 is made of gold. The wetting layer 16 promotes direct wettability of the soldering alloy to the diffusion barrier layer 12.

The wetting layer 16 is a thin film that has a thickness of between about 5 nanometers and 1 micron. Preferably, the wetting layer 16 has a thickness of about 50 nanometers. The wetting layer is a sacrificial layer which will be absorbed by the solder, i.e; by the tin-silver alloy or the tin-silver-copper alloy. This gold layer disappears after the soldering process. This gold layer is added to enhance the adhesion of the tin-silver alloy or the tin-silver-copper alloy. The tie layer 8, the diffusion barrier layer 12 and the wetting layer 16 are, for example, produced by sputtering or by evaporation.

During a step 18, a solder 20 is applied between the metallized substrate 4 and the conducting face 25 of the conducting body. The solder 20 is made of a tin-silver alloy or of a tin-silver-copper alloy. According to the invention, the solder 20 is deposited directly or straightly on the wetting layer 16, i.e. without any other intermadiaire layer.

The wetting layer 16 is a thin film having a thickness approximately equal to 0.4% of the thickness of the solder 20.

The solder joint produced by this soldering method includes a thin-film trilayer applied on the substrate 4. This trilayer comprises the tie layer 8, the diffusion barrier layer 12 and the wetting layer 16. This trilayer has a thickness of less than 3 microns and preferably less than 1 micron.

FIG. 2 shows an example of a soldered part 21 manufactured according to the soldering method described above. In this example, the soldered part 21 is a portion of an electronic circuit of the SMC (Surface Mounted Component) type. This electronic circuit comprises a substrate 4, and in particular an alumina or silica wafer, and a conducting body 2 formed by an electronic component 23, the vertical lateral faces 25 of which are metallized.

As a variant, the soldered part is, for example, an electronic component, a hybrid circuit, a sensor, etc.

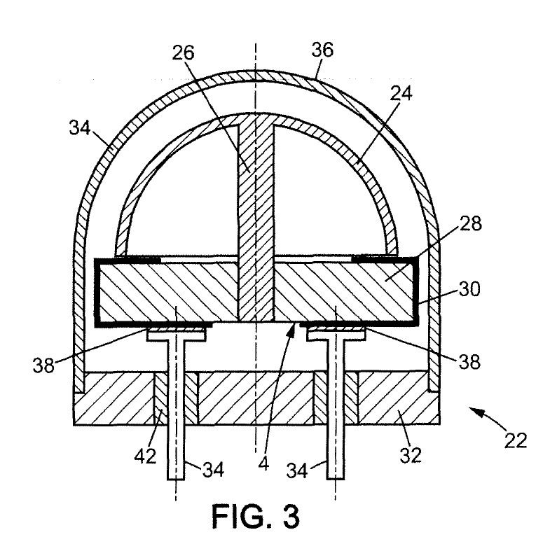

Referring to FIG. 3, a gyroscope 22 manufactured by implementing the soldering method according to the invention comprises a resonator 24 of bell shape or spherical cap shape, which has a shaft 26 for fastening it, and a part 28 carrying electrodes 30, called hereafter electrode carrier 28, in which the shaft 26 of the resonator 24 is anchored. The resonator 24 is made of silica and the electrode carrier 28 is made of a ceramic or of silica in order to ensure stability of the air gaps.

The electrode carrier 28 may be hemispherical with electrodes placed facing the internal face of the resonator 24. In this case, the internal face of the resonator 24 extends around the outer perimeter of the electrode carrier 28 (not shown).

The electrode carrier 28 may also be flat with electrodes 30 placed facing the end face of the resonator 24, as illustrated in FIG. 3.

The gyroscope 22 further includes a base 32, rods 34 for supporting the electrode carrier 28, for example made of Kovar®, and a cover 36 fastened to the base 32.

The support rods 34 form an arrangement in which the electrode carrier 28 is mounted on the base 32 via “piles”. This “pile” mounting arrangement makes it possible, in the case of thermal expansion, for the electrode carrier 28 to move translationally parallel to the base 22. This translational movement is obtained by deformation of the support rods 34. This “pile” mounting arrangement is described in patent FR 2 805 039.

For example, eleven support rods 34 support the electrode carrier 28. The support rods 34 are conducting. They are fastened to the underside of the electrode carrier 28 and in particular to the electrodes 30, so as to ensure electrical connection between the electrodes 30 and the support rods 34. Some of the support rods 34 may conduct excitation signals or detection signals of the resonator. Other support rods 34 merely provide the electrode carrier 28 with stability.

According to the invention, the soldering method illustrated in FIG. 1 is implemented in order to fasten the support rods 34 to the electrodes 30 of the electrode carrier. In particular, the soldering method is implemented in order to produce the solder joint 38.

The base 32 is a circular part that carries, in the example illustrated, eleven insulating vacuum-tight bushings 42 through which the support rods 34 are engaged.

The cover 36 defines with the base 32 an hermetically sealed enclosure in which a high vacuum is created. A getter material is generally provided in conjunction with said enclosure so as to absorb the residual gases therein after outgassing and sealing.

As a variant, the support rods are made of a metal.

The soldering method described in the present patent application with reference to FIG. 3 makes it possible to produce a gyroscope with a resonator of bell shape or spherical cap shape. However, it may also be implemented for producing other sensors having a cell supported by conducting support rods.

Advantageously, the soldering method according to the invention may also be used to solder hybrid circuits, sensors, rods, pads, connectors, components, or for making connections between two substrates for MEMS devices or for sealing vacuum-tight covers onto substrates.

Advantageously, the soldering method makes it possible to solder materials that are not naturally solderable, such as crystalline substrates, ceramics, glass frit and weakly elastic materials.

Advantageously, the tin-silver alloy has a stiffness greater than that provided by any other type of soldering or other type of assembly, such as adhesive bonding. This stiffness stabilizes the frequency plane of the gyroscope. The alloy increases the impact strength of the gyroscope.

Advantageously, by implementing the soldering method according to the invention in a gyroscope, it is possible to compensate for the differential expansion between the Kovar® support rods and the substrate.

Advantageously, the outgassing of the solder produced according to the method of the invention is negligible compared with the outgassing from adhesives under high vacuum. As a consequence, all the gases beneath the cover are easily pumped by their getter.

Advantageously, since the tin-silver alloy and the tin-silver-copper alloy have a melting point of 230° C., it is possible to increase the outgassing temperature up to about 200° C. in order to ensure a better vacuum beneath the cover.

Advantageously, unlike conducting adhesives, the electrical continuity between the electrodes and the support rods is ensured over time.

Advantageously, and contrary to adhesive bonding, the soldering of the substrate to the body according to the method of the invention does not lose its mechanical stiffness over the course of time.

The embodiments above are intended to be illustrative and not limiting. Additional embodiments may be within the claims. Although the present invention has been described with reference to particular embodiments, workers skilled in the art will recognize that changes may be made in form and detail without departing from the spirit and scope of the invention.

Various modifications to the invention may be apparent to one of skill in the art upon reading this disclosure. For example, persons of ordinary skill in the relevant art will recognize that the various features described for the different embodiments of the invention can be suitably combined, un-combined, and re-combined with other features, alone, or in different combinations, within the spirit of the invention. Likewise, the various features described above should all be regarded as example embodiments, rather than limitations to the scope or spirit of the invention. Therefore, the above is not contemplated to limit the scope of the present invention.

1. A method of soldering an at least partially conducting body to a substrate using an alloy chosen from either a tin-silver alloy or a tin-silver-copper alloy, the method comprises the following steps:
metallizing the substrate, said metallizing step comprising of depositing a tie layer on the substrate and a step of depositing a diffusion barrier layer, said tie layer having any one of the chemical components chosen from chromium, titanium or a titanium alloy, said diffusion barrier layer comprising a material chosen from platinum or palladium; and
applying a solder between the conducting body and the substrate, said solder comprising an alloy chosen from a tin-silver alloy or a tin-silver-copper alloy; wherein
the method further includes depositing a wetting layer; said wetting layer comprising gold; said wetting layer being deposited between the step of depositing a diffusion barrier layer and the step of applying a solder.

2. The soldering method according to claim 1, in which the tie layer is a thin film having a thickness of between 5 and 50 nanometers.

3. The soldering method according to claim 1, in which the tie layer has a thickness of about 30 nanometers.

4. The soldering method according to claim 1, in which the diffusion barrier layer is a thin film having a thickness of between about 100 nanometers and 1500 nanometers.

5. The soldering method according to claim 1, in which the diffusion barrier layer has a thickness of about 200 nanometers.

6. The soldering method according to claim 1, in which the solder is deposited straight on the wetting layer.

7. The soldering method according to claim 1, in which the wetting layer is a thin film having a thickness approximately equal to 0.4% of the thickness of the solder.

8. The soldering method according to claim 1, in which the wetting layer is a thin film having a thickness of between about 5 nanometers and 1 micron.

9. The soldering method according to claim 1, in which the wetting layer has a thickness of about 50 nanometers.

10. The soldering method according to claim 1, in which the tie layer comprises chromium and in which the diffusion barrier layer comprises platinum.

11. A gyroscope comprising:
a resonator;
a substrate supporting the resonator; and
an at least partially conducting body, fastened to the substrate,
wherein the conducting body is fastened by a solder to the substrate by implementing the soldering method according to claim 1.

12. The gyroscope according to claim 11, in which the substrate includes at least one excitation/detection electrode, said electrode being connected to the body.

13. A soldered part comprising at least a substrate and an at least partially conducting body, fastened to the substrate, wherein the conducting body is fastened by a solder to the substrate by implementing the soldering method according to claim 1.
